(19) United States
(12) Patent Application Publication
(10) Pub. No.: US 2026/0320514 A1
(43) Pub. Date: Oct. 15, 2026

(54) DATA ITEM MANAGEMENT USING MACHINE LEARNING

(71) Applicant: DevRev, Inc., Palo Alto, CA (US)

(72) Inventors: Ashwini Vasanth, West Lafayette, IN (US); Dominik Damjakob, Austin, TX (US); Safet Hoxha, Austin, TX (US); Emily Dworkin, Milpitas, CA (US); Shlomi Vaknin, San Jose, CA (US)

(73) Assignee: DevRev, Inc., Palo Alto, CA (US)

(21) Appl. No.: 19/722,640

(22) Filed: Jun. 26, 2026

Related U.S. Application Data
(63) Continuation of application No. 18/634,612, filed on Apr. 12, 2024.

(51) Int. Cl. G06Q 10/0631

(52) U.S. Cl. CPC G06Q 10/0631

(57) ABSTRACT

The present subject matter discloses techniques to identify linkable items and accordingly generating recommendations indicating such linkages. One or more work data objects, each linked with a corresponding work item, may be obtained. Further, one or more support data objects, each linked with a corresponding support item, may be obtained. The one or more work data objects and the one or more support data items may be encoded into work vectors and support vectors, respectively. A similarity score may then be estimated based on a quantitative comparative assessment of the work and support vectors. The similarity score may indicate a contextual similarity between each of the one or more work data objects and the one or more support data objects. Based on the similarity score, the one or more support items may be linked with the one or more work items.

### CROSS-REFERENCE TO RELATED APPLICATIONS

The present application claims the benefit of priority to U.S. Application Ser. No. 18/634,612, which is hereby incorporated by reference in its entirety.

### BACKGROUND

Certain organizations may develop and offer various services in form of products, platforms, and/or other possible modes in a connected and collaborative computing environment. For example, various support and work management products and platforms have been developed to build a connected and collaborative computing environment for users belonging to different verticals and ecosystems. For instance, products and platforms may include one or more ecosystems inhabited by user-end entities and developer-end entities. The developer-end entities may perform various tasks associated with development of a service being offered, such as a software product and/or platform, including creation or deployment of various roadmaps or work items. On the other hand, a user(s), that may be working in a same or different ecosystem and interacting with the offered services, may create and submit different support items associated with functioning and performance of the software product and/or platform. Under different scenarios, it may be necessary to correlate or associate work items with support items to understand, for example, requirements of the user-end entities and accordingly determine necessary directions for development and modifications of the services being offered.

### BRIEF DESCRIPTION OF FIGURES

The drawings illustrate the design and utility of various embodiments of the invention. It should be noted that the figures are not drawn to scale and that elements of similar structures or functions are represented by reference numerals throughout the figures. In order to better appreciate how to obtain the above-recited and other advantages and objects of various embodiments of the invention, a detailed description of the present subject matter will be rendered by reference to specific embodiments thereof, which are illustrated in the accompanying drawings. Understanding that these drawings depict only typical embodiments of the invention and are not therefore to be considered limiting of its scope, the present subject matter will be described and explained with additional specificity and detail through the use of the accompanying drawings.

FIGS. 1A and 1B provide an illustration of a computing environment, in accordance with an example implementation of the present subject matter.

FIG. 2A illustrates a computing environment comprising a system, according to one example of the present subject matter.

FIG. 2B schematically illustrates communication between different components of the computing environment, according to one example of the present subject matter.

FIG. 2C schematically illustrates updating work and support data objects, according to one example implementation of the present subject matter.

FIG. 3 illustrates a method to generate recommendations by identifying linkable items, according to an example implementation of the present subject matter.

FIG. 4 illustrates a computing environment implementing a non-transitory computer readable medium for generate recommendations by identifying linkable items, according to an example implementation of the present subject matter.

### DETAILED DESCRIPTION

With advancement in technology, different types of connected and collaborative computing environments have been developed and are evolving. Such computing environments, in relation to a particular product and/or service, include one or more distinct ecosystems inhabited by user-end entities and developer-end entities. The user-end entities may include, for example, one or more users, customers, clients, and the like that may use or interact with deployed services or service offerings, for example in form of products and/or platforms. The developer-end entities may include, for example, product managers, tech leads, developers, engineers, and the like that mainly focus on development and enhancement of the products and/or services. Each of the one or more distinct ecosystems, while operating, may produce a stream of data or items that describe an activity or change in the ecosystems. For instance, the developer-end entities may perform various tasks associated with development of the service offerings, including creation or deployment of various roadmap or work items. Such work items may include, for example, enhancements, bug reports, feature proposals, logs of work done, notes indicating feature modifications and updated, and the like that may be created by the developer-end entities. Whereas, one or more users, interacting with the software product and/or platform, may create and submit different support items, such as in form of operation requests reflecting feedbacks, queries, feature requests, and problems associated with functioning and performance of the service offerings. Such support items may also be referred to as tickets raised by the one or more users.

In many cases, linking or association of such work items and support items may be, or may become, necessary. For instance, linking the work items and the support items may help the developer-end entities in understanding requirements of the user-end entities with respect to the proposed developments. The requirements may include, for example, request for addition/modification/removal of any feature(s) associated with the service offerings, such as one or more product and/or services, bugs, and the like. By understanding the requirements of the user-end entities, the developer-end entities may be able to determine if a particular work item, say proposal for addition of a feature for the product or other services being offered, is demanded by the user-end entities, say users of the product or the other services being offered. Such determinations may help the developer-end entities in deciding which work items, from among a plurality of work items, may have greater necessity or requirement. Development of the services being offered may accordingly be directed in required direction.

However, linking the work items, the support items, and any other similar items is generally performed manually which faces several challenges. For example, manually linking the work items and the support items may be cumbersome because the work items and the support items are generally created at different points in time. In a collaborative computing environment having, for instance, multiple developer-end entities and user-end entities may create or submit the work items and the support items, respectively, at different points in time. Also, considering a large number of such work items and support items, manual identification of linkable work and support items and forming an association therebetween may become complex, time consuming, and prone to errors, including formation of incorrect linkages. Furthermore, since the distinct ecosystems may typically be isolated from one another, it may be difficult to effectively perform the analysis for identifying linkable work items and support items as they may span across distinct ecosystems or boundaries.

Further, data objects, such as textual and non-textual descriptions associated with the work items and the support items are required to be manually searched in order to find linkable work items and support items. Since such items are created by different entities, the perspective with which the data objects are created may be different. The content of the data objects may thus significantly vary. Identifying linkable work items and support items, for instance, by simple keyword search, given they are created by different entities with different perspectives, may thus be difficult. Therefore, there exist multiple challenges associated with manual identification of linkable items and formation of the linking therebetween.

The present subject matter discloses techniques to efficiently identify linkable items and accordingly generate recommendations indicating such possible linkages. The items may be any items that may either be associated with a single environment or with different environments, such as developer computing environment(s) and user computing environment(s). The developer computing environment(s) may be environment(s) comprising one or more developer-end entities that may work on development and enhancement of one or more services being offered, interchangeably be referred to as service offerings. Examples of the service offerings may include, but are not limited to, products, platforms, and applications. The user computing environment(s) may be environment(s) comprising one or more user-end entities that may use or interact with developed and/or offered services. Each of the one or more distinct ecosystems, while operating, may produce stream(s) of data or items. The items may include, for example, work items and support items. Examples of the work items may include, but are not limited to, enhancements, bug reports, feature proposals, logs of work done, notes indicating feature modifications and updates, and the like that may be created by the developer-end entities. Examples of the support items may include, but are not limited to, one or more queries, feedbacks, feature requests, and problems associated with functioning and performance of the services being offered. The support items, in one example, may be in form of operational requests or tickets that may be created and/or submitted by the user-end entities.

The work items and support items may have, in one example, associated work data objects and support data objects, respectively. Each of the work data objects may have associated descriptor variables. In one example, at least one descriptor variable may be embedded in the corresponding work data objects. In another example, the at least one descriptor variable may be linked to the corresponding work data objects. The at least one descriptor variable may be, for example, a textual description and/or a non-textual description. For instance, the work data objects may include the textual description that may be provided by the developer-end entities while creation and/or modification of the corresponding work item. The textual description may include, for example, title, description, comments, tags, and the like. The non-textual description may include, for example, one or more images, graphs, point clouds, pixel data, 3-dimensional image, audio data, encoded or encrypted messages, or any data being represented in non-textual format.

Further, each of the support data objects may include at least one another descriptor variable associated therewith. In one example, the at least one other descriptor variable may be embedded in the corresponding support data objects. In another example, the at least one other descriptor variable may be linked to the corresponding support data objects. The at least one other descriptor variable may be, for example, textual descriptions and/or non-textual descriptions. For instance, the textual description may be textual information provided by the user-end entities while creation and/or modification of the support items. The textual information may be in form of, for example, one or more queries, feedbacks, feature requests, and the like. Further, the non-textual description may include, for example, one or more images, pixel data, 3-dimensional image, audio data, encoded or encrypted messages, or any data being represented in non-textual format.

According to one example of the present subject matter, one or more work data objects, each linked with a corresponding work item from amongst a plurality of work items, may be obtained. In one example, the plurality of work items may be associated with development of the one or more service offerings. Each of the one or more work data objects comprises at least the descriptor variable associated with the corresponding work item. Further, one or more support data objects, each being associated with a corresponding support item from among a plurality of support items, may be obtained. Each of the one or more support data objects comprises at least the other descriptor variable associated with the corresponding support item. The one or more work data objects associated with each of the plurality of work items and the one or more support data objects associated with each of the plurality of support items may be encoded into work vectors and support vectors. In one example, the work vectors and the support vectors may be numerical vectors that may be derived based on the at least one descriptor variable and the at least one other descriptor variable embedded within the one or more work data objects and the one or more support data objects, respectively. A similarity score may then be estimated based on a quantitative comparative assessment of the work vectors and the support vectors. The similarity score, in one example, may be indicative of a contextual similarity between each of the one or more work data objects and each of the one or more support data objects. The contextual similarity may be indicative of, in one example, semantic similarity or relationship if the at least one descriptor variable and the at least one other descriptor variable include textual information or description. However, if the at least one descriptor variable and the at least one other descriptor variable include non-textual information or description, say images, the contextual similarity may be indicative of relationship between pixels of images embedded within the one or more work data objects and each of the one or more support data objects. In other examples, the contextual similarity may also be indicative of any other logical or analytical similarity or relationship between the work items and support items.

Based on the similarity score, it may be determined whether the one or more support items, from among the plurality of support items, are linkable with the one or more work items, from among the plurality of work items. Thus, based on the similarity score, the one or more support items may be linked with the one or more work items. A recommendation may accordingly be generated to indicate the one or more support items being linked with the one or more work items. The recommendation may thus be indicative of a possible correlation, or similarity, between the one or more work items and the one or more support items.

Further, in one example of the present subject matter, a reasoning indicator may be rendered to indicate a reason for linking the one or more support items with the one or more work items. The reasoning indicator may be, in one example, a reason or explanation indicating why such linkages may be recommended. In one example, the reasoning indicator may also indicate a reason or explanation indicating why such any form of linkage between the one or more support items with the one or more work items may not be recommended.

Furthermore, in one example of the present subject matter, a feedback option may also be rendered to receive at least one of a positive feedback and a negative feedback, the positive feedback indicating acceptance of the linking being recommended and the negative feedback indicating rejection of the recommended linking. In one example, the feedback may be received from the developer-end entities and may be used for fine tuning of further or subsequent linkage recommendations. In one example, on receiving the positive feedback, the linkable work items and support items, may be linked or associated with each other. For instance, on receiving the positive feedback, a list indicating the one or more work items linked with the one or more support items may be rendered. The list may indicate, in one example, the one or more work items linked with the one or more linkable support items. Therefore, the linkable support items may be automatically clustered and linked or associated with the one or more corresponding work items.

The present subject matter addresses the problems associated with the conventional techniques for linking items, including at least those associated with the manual linking techniques. For example, by determining the similarity score, relevance or similarity between work and support data objects may be determined based on their meaning or logic and not only, for instance, the keywords used or present therein. Thus, by determining the similarity score, the support items that are likely to be relevant to the work items may be determined, and vice versa, even if the associated support and work data objects were created with different perspectives by the developer-end entities and the user-end entities. Therefore, even with variations in data objects, including textual an/or non-textual variations, it may become possible to identify work and support items that may be linkable with each other.

Further, the support items that may be likely relevant, or contextually similar, to one or more work items may be recommended and linked with each other. Thus, it may become possible to receive an overview of the support items that are linkable with the one or more work items. Such recommendation may, for example, help the developer-end entities in understanding whether the one or more work items are required or demanded by the user-end entities. For example, in view of such recommendations and/or linking, it may become possible to identify how many support items appear to be suitable for being linked with the work items. It may thus become possible to ascertain trending or highly demanded requirements of the user-end entities, or problems faced by the user-end entities. The developer-end entities may accordingly be able to determine the one or more work items that are required to be prioritized and necessary directions and actions for development and modifications of the service offerings, such as the products and/or platforms.

Further, by indicating the reason, user(s), such as the developer-end entities, may be able to verify if the linkage being recommended is justified, thereby being able to be aware of authenticity and/or accuracy of the identified linkages. Furthermore, future or subsequent linkage recommendations may be fine tuned based on the feedback received for the linkage. For example, if negative feedback is received, say from the developer-end entities, it may be determined that the linkage being recommended may not be appropriate or accurate. Similarly, if negative feedback is received, it may be determined that the linkage may be acceptable and considerably appropriate or accurate. Such feedback may be used for fine tuning future or subsequent linkage recommendations.

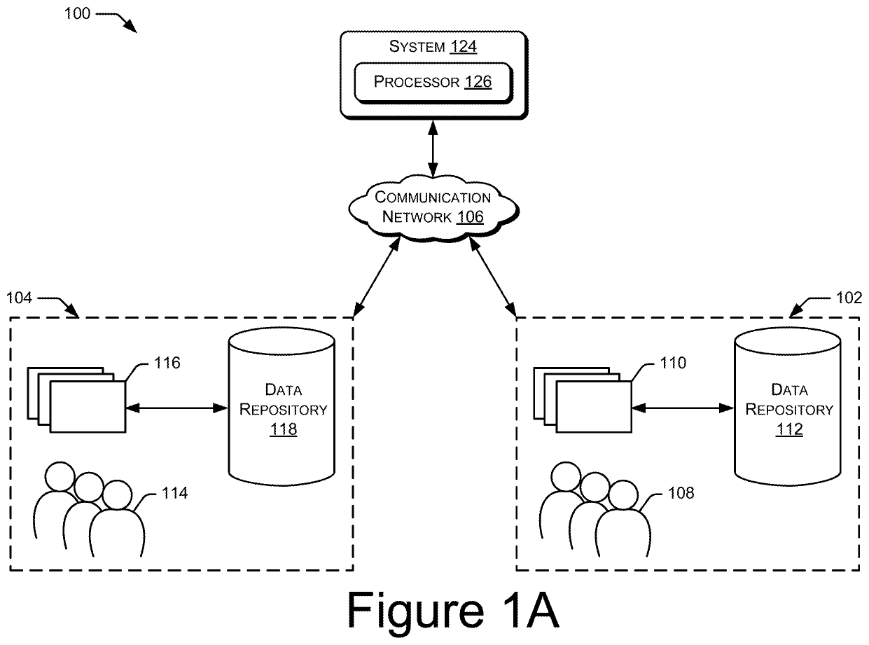

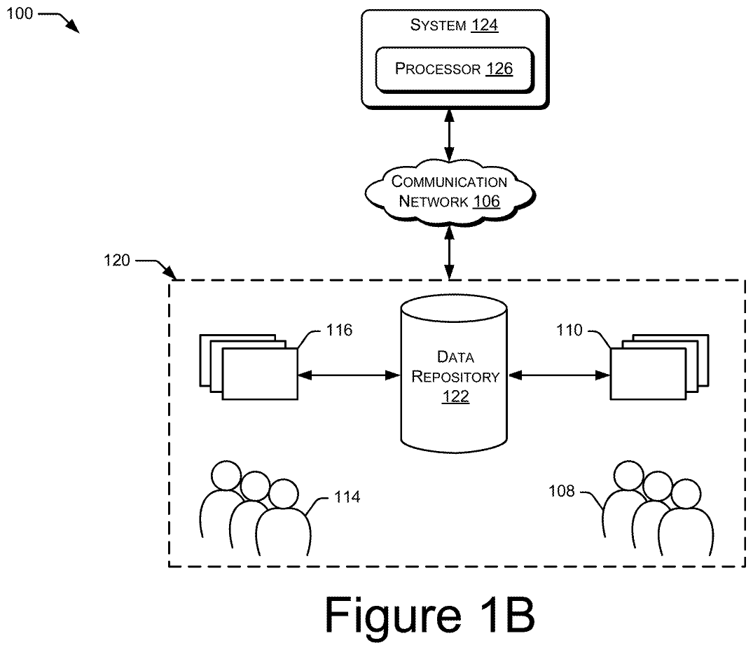

The present subject matter is further described with reference to FIGS. 1A-4 It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIGS. 1A and 1B provide an illustration of a computing environment 100, in accordance with an example implementation of the present subject matter. For the sake of brevity, FIGS. 1A and 1B may be discussed in conjunction with each other.

In one example, the computing environment 100 may include one or more communicably interconnected computing environments or ecosystems. For example, as illustrated in FIG. 1A, the computing environment 100 may include a first ecosystem 102 and a second ecosystem 104 that may be communicably coupled with each other over a communication network 106. The communication network 106 may be a wireless network, a wired network, or a combination thereof. The communication network 106 may also be an individual network or a collection of many such individual networks, interconnected with each other and functioning as a single large network, e.g., the Internet or an intranet. Examples of such individual networks include local area network (LAN), wide area network (WAN), the internet, Global System for Mobile Communication (GSM) network, Universal Mobile Telecommunications System (UMTS) network, Personal Communications Service (PCS) network, Time Division Multiple Access (TDMA) network, Code Division Multiple Access (CDMA) network, Next Generation Network (NGN), Public Switched Telephone Network (PSTN), and Integrated Services Digital Network (ISDN). Depending on the technology, the communication network 106 may include various network entities, such as transceivers, gateways, and routers. In an example, the communication network 106 may include any communication network that uses any of the commonly used protocols, for example, Hypertext Transfer Protocol (HTTP), and Transmission Control Protocol/Internet Protocol (TCP/IP).

In one example, the first ecosystem 104 may be a computing environment including one or more developer-end entities 108. In one example, the one or more developer-end entities 108 may be entities majorly focused towards maintenance, development, and enhancement of various services being offered, such as applications, software, webpages, databases, and other products and/or platforms. Examples of the one or more developer-end entities 108 may include, but are not limited to, product managers, tech leads, developers, engineers, and the like. The developer-end entities 108 may perform various tasks associated with the products and/or services. One such task may include, for example, creation of various roadmap or work items 110 associated with the services being offered or under development. Examples of the work items 110 may include, but are not limited to, enhancements, bug reports, feature proposals, logs of work done, notes indicating feature modifications and updated, and the like. Further, each of the work items 110 may have one or more corresponding work data objects associated therewith. The work data objects may include, or have associated therewith, any information that may be descriptive of the corresponding work item. The information may be textual or non-textual information. In one example, each of the work data objects may have associated at least one descriptor variable. The at least one descriptor variable may be textual descriptions and/or non-textual descriptions. For instance, each of the work data objects may include a textual description that may be provided by the developer-end entities while creation and/or modification of the corresponding work item. The textual description may include, for example, title, description, comments, tags, and the like. The non-textual description may include, for example, one or more images, graphs, point clouds, pixel data, 3-dimensional image, audio data, encoded or encrypted messages, or any data being represented in non-textual format. The work data objects may also include, or be embedded with, any other type and format of description associated with the corresponding work item. The work data objects, in one example, may be created by the one or more developer entities 108 and may be stored in a data repository 112 associated with the first ecosystem 102. In another example, the descriptor variable may be stored as a data object in the data repository 112. The data repository 112 may be any repository or storage unit implemented by physical, logical, and/or virtual storage devices configured to store the work items 110 and the one or more work data objects associated therewith.

In one example, the work items 110 may have a hierarchy following a parent-child-like relationship. For example, the work items 110 may have features or capabilities as parent and enhancements associated with the work items 110 as children. Thus, the work items 110 may internally follow a hierarchy where the features or capabilities (i.e., parent) and the enhancements (children) may be linked like a parent-child in a hierarchy regime.

Further, the second computing ecosystem 104 may be a computing environment including one or more user-end entities 114. In one example, the one or more user-end entities 114 may be entities that may use or interact with the services being offered or developed. In one example, the services being offered or developed may be associated and/or developed by the developer-end entities 108 and accessed by the one or more user-end entities 114. Examples of the one or more user-end entities 114 may include, but are not limited to, users, customers, clients, one or more organizations, and the like. The one or more user-end entities 114 may perform various tasks associated with the services being offered. One such task may include, for example, creation of various support items 116 associated with the services being offered or developed. For instance, the support items may be associated with an operational request linked to the services being offered or developed. Examples of the support items 116 may include, but are not limited to, feedbacks, feature requests, follow-up queries, and problems associated with functioning and performance of the services that may be created and/or submitted by the one or more user-end entities 114. In one example, the support items 116 may be one or more tickets created and/or raised by the user-end entities 114 for raising any concerns or operation requests linked or associated with the services being offered or developed, where the services being offered or developed may be associated with the developer-end entities 108.

In one example, the work items 110 and the support items 116 may be created, raised, or submitted by the developer-end entities 108 and the user-end entities 114, respectively, using a platform or a user interface (not shown). In another example, the work items 110 and the support items 116 may be created, raised, or submitted by the developer-end entities 108 and the user-end entities 114, respectively, using different platforms or user interfaces (not shown) communicably linked with each other. Examples of the platform(s) and the user interface(s) may include, but are not limited to, one or more webpages, a software application, a graphical user interface (GUI), execution of one or more scripts, one or more Application Programming Interface (API) calls, and the like.

Further, each of the support items 116 may have one or more corresponding support data objects associated therewith. The support data objects may be any information that may be descriptive of the corresponding support item. For example, each of the support data objects may include at least one another descriptor variable associated therewith. The at least one other descriptor variable may be, for example, textual descriptions and/or non-textual descriptions. For instance, the textual description may be textual information provided by the user-end entities 114 while creation and/or modification of the support items 116. The textual information may be in form of, for example, one or more queries, comments, title, feedbacks, feature requests, and the like. Further, the non-textual description may include, for example, one or more images, pixel data, 3-dimensional image, audio data, encoded or encrypted messages, or any data being represented in non-textual format.

Further, the support data objects, in one example, may be created by the one or more user-end entities 114 and may be stored in a data repository 118 associated with the second ecosystem 104. In another example, the at least one other descriptor variable may be stored as a data object in the data repository 118. The data repository 118 may be any repository or storage unit implemented by physical, logical, and/or virtual storage devices configured to store the support items 116 and the one or more support data objects associated therewith.

In another example, the computing environment 100 may have a single computing environment or ecosystem, as illustrated in FIG. 1B, where the developer-end entities 108 and the user-end entities 114 may be located within a single computing environment 120. In such an environment, there may be a common data repository 122, similar to the data repositories 112 and 118. The data repository 122 may be configured to store the work items 110, the support items 116, and their corresponding work and support data objects.

In one example, the computing environment 100 may include a system 124. In one example, the system 124 may be communicably coupled with one or more computing environments, such as the environments 102, 104, and 120 using the communication network 106, as illustrated in FIGS. 1A and 1B.

The system 124 may be configured to, in one example, efficiently identify linkable items and accordingly generate recommendations indicating such possible linkages. The items may be, for example, the work items 110 and the support items 116. In one example, the system 124 may be communicably coupled with a data repository to access the work items 110 and the support items 116. The system 124 may be communicably coupled, in one example, with the data repository 112 to access the work items 110 and with the data repository 118 to access the support items 116 available therein. In another example, the system 124 may be communicably coupled with a single data repository, such as the data repository 122 to access the work items 110 and the support items 116 available therein. Though it has been illustrated that the system 124 may be communicably coupled with one or more environments, it may be possible, in one example, that the environments are a part of the system 124. That is, the system 124 may be formed by the one or more environments. For instance, the system 124 may include the one or more of the environments 102, 104, and 120, or at least some of the components of the environments, such as the data repositories. For the sake of brevity, the data repositories 112, 118, and 122 may individually be referred to as data repository and collectively be referred to as data repositories.

In one example, the system 124 may include a processor 126. Examples of the processor 126 may include, but are not limited to, microprocessors, microcomputers, microcontrollers, digital signal processors, central processing units, state machines, logic circuitries, Artificial Intelligence (AI) based processors, processing circuitries including one or more modules or engines, and/or any other devices that manipulate signals and data based on computer-readable instructions.

In one example, the processor 126 may obtain one or more work data objects, each being linked with a corresponding work item from amongst a plurality of work items, such as the work items 110. Each of the one or more work data objects may include at least the descriptor variable associated with the corresponding work item. The processor 126 may, in one example, further obtain one or more support data objects, each being linked with a corresponding support item from amongst a plurality of support items, such as the support items 116. Each of the one or more support data objects may include at least the other descriptor variable associated with the corresponding support item. In one example, the processor 126 may obtain the one or more work data objects and the one or more support data objects by accessing a data repository, such as one or more of the data repositories 112, 118, and 120.

Further, the processor 126 may, or may be configured to, analyze the one or more work data objects and the one or more support data objects to identify linkable work items 110 and support items 116. In one example, the at least one descriptor variable associated with each of the work items 110 and the at least one other descriptor variable associated with each of the support items 116 may be analyzed by the processor 126 to identify linkable work items 110 and support items 116.

In one example, the processor 126 may determine a contextual similarity between each of the one or more work data objects and each of the one or more support data objects to identify linkable work items 110 and support items 116. The contextual similarity may be indicative of, in one example, semantic relationship if the at least one descriptor variable and the at least one other descriptor variable include textual information or description. However, if the descriptor variable and the other descriptor variable include non-textual information or description, say images, the contextual similarity may be indicative of relationship or similarity between pixels of images embedded within the one or more work data objects and each of the one or more support data objects.

In one example, if the at least one descriptor variable and the at least one other descriptor variable include textual information or description, the semantic similarity may be determined using one or more deep learning models and by generating vectors. For example, one or more deep learning models may be used for encoding the at least one descriptor variable associated with each of the plurality of work items 110 into work vectors and the at least one other descriptor variable associated with each of the plurality of support items 116 into support vectors. The work and support vectors may be, for example, numerical vectors derived based on the textual description associated with the corresponding work items 110 and the corresponding support items 116.

However, in another example, if the at least one descriptor variable and the at least one other descriptor variable include non-textual information, say images, pixel similarity may be determined. The pixel similarity may indicate a logical or analytical similarity between one or more pixels of the images associated with the work items 110 and the support items 114. In one example, the pixel similarity may be determined using a trained model, such as a machine learning model, that may analyze pixels, or pixel level data, associated with the images to determined similarity therebetween. In one example, the pixel level data may indicate a position of each pixel associated with the images. The pixels, or the pixel level data, may accordingly be processed to obtain the work vector and the support vectors. For example, the pixels, or the pixel level data, may be converted into numerical vectors.

Further, to identify linkable work items 110 and support items 116, the processor 126 may perform, in one example, a quantitative comparative assessment of the work vectors and the support vectors to estimate a similarity score. The similarity score, in one example, may be indicative of the contextual similarity. The quantitative comparative assessment may be any method, principle, or rule for assessing rational, logical, semantic, and/or analytical similarity between the support vectors and the work vectors. In one example, the processor 126 may perform the quantitative comparative assessment by performing a mathematical method for comparing the work vectors and the support vectors to identify how similar the work vectors and the support vectors are with respect to each other. Based on the comparison, the processor 126 may estimate the similarity score. The similarity score may indicate an extent of contextual similarity between the work vectors and the support vectors. For example, the similarity score may thus be indicative of a semantic relationship, or similarity, between each of the one or more work data objects and each of the one or more support data objects. Other techniques to determine semantic relationship may also be used. Based on the estimated similarity score, the processor 126 may be configured to determine the one or more work data objects and the one or more support data objects that may possibly be contextually similar to each other.

Based on the similarity score, the processor 126 may determine the one or more support items, from amongst the plurality of support items 116, being linkable with the one or more work items, from amongst the plurality of work items 110. For example, if the similarity score is determined to be more than a predefined threshold, the work and support vectors (and thereby the corresponding work and support data objects) may be ascertained to be contextually similar to each other. The processor 126 may accordingly link the one or more support items 116 with the one or more work items 110. In one example, the one or more support items 116 (for example, one or more tickets) may be linked or associated with a part of the one or more work items 110 (for example, the feature or capability), where the one or more work items 110 follow the parent-child-like hierarchy. For instance, the processor 126 may link the one or more support items 116 (tickets) with a child (for example, enhancement) of the one or more work items 110 (i.e., the feature or capability).

In one example, the linkage may indicate a relation between the one or more support items 116 and the one or more work items 110. In one example, the linkage may be indicated in form of a list (not shown) indicating the one or more support items 116 being associated with one or more work items 110. Therefore, the linkable or suitable support items 116 may automatically be associated or linked with the one or more work items 110.

Further, in one example, the processor 126 may render a reasoning indicator to indicate a reason for linking the one or more support items with the one or more work items. In one example, the reasoning indicator may be a textual indicator including information indicating a probable reason for such linkage. In one example, the reason indicator may indicate the similarity score, the similarity score being the probable reason for such linkage. In another example, other reasons may also be determined by the processor 126 by using different possible techniques. In one example, the processor 126 may use a large language model (LLM). The LLM may have reasoning capabilities and may determine dynamic reasons based on the at least one descriptor variable and the at least one other descriptor variable associated with the corresponding work items 110 and the corresponding support items 116. For example, the processor 126 may query the LLM to reason whether the one or more support items 116 actually fit, or are similar, to the one or more work items 110. For instance, the processor 126 may interact with, or query the LLM to determine whether the one or more support items 116, each having associated at least one other descriptor variable, fits with the one or more work items 110, each having the at least one descriptor variable associated therewith. In response, the LLM being, in one example, a generative model, may generate information, i.e., the reason. In one example, the reason may be dynamic and indicative of whether, or to what extent, the one or more support items 116 are suitable for being linked with the one or more work items 110. In one example, the reason may be indicative of why the one or more support items 116 are being linked with the one or more work items 110. Also, in one example, the LLM may generate another reason to indicate why the one or more support items 116 must not be linked with the one or more work items 110. Based on the reasonings generated, the processor 126 may thus also be configured to filter one or more support items 116 linkable with one or more work items 110. Further, it may also be possible to use models other than, or along with, the LLM to determine the reason.

In one example, the processor 126 may further render a feedback option to receive at least one of a positive feedback and a negative feedback, the positive feedback indicating acceptance of the linkage and the negative feedback indicating rejection of the linkage. In one example, the feedback may be received from the developer-end entities and may be used for tuning further or subsequent linking of the one or more support items 116 and the one or more work items 110. The processor 126, in one example, may have learning capabilities and, based on the learning from feedbacks received on past linkages, may accordingly tune subsequent linkings.

In one example, on receiving the positive feedback for the generated linking, the processor 126 may ascertain that linking of the one or more work items 110 and the one or more support items 116, as determined, is appropriate. By ascertaining such appropriateness, the processor 126 may get configured, for example learn, that similar linking may be performed for similar work items and support items. However, on receiving the negative feedback for the generated linking, the processor 126 may ascertain that linking of the one or more work items 110 and the one or more support items 116, as determined, is to be avoided.

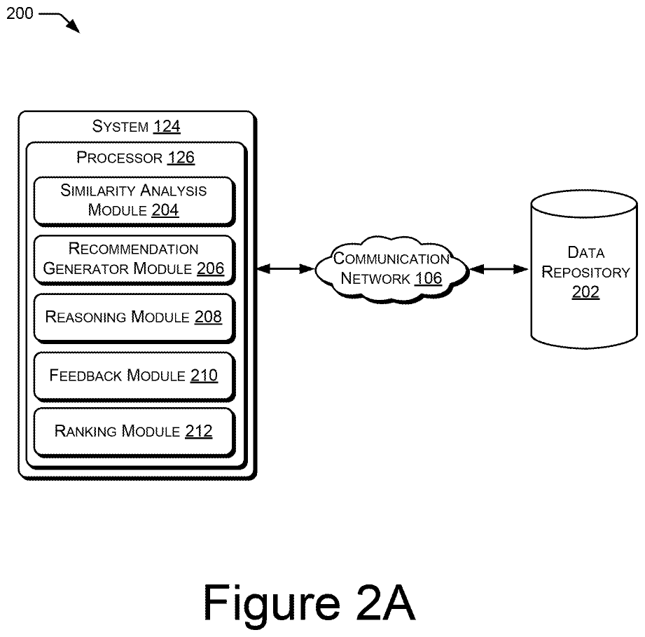

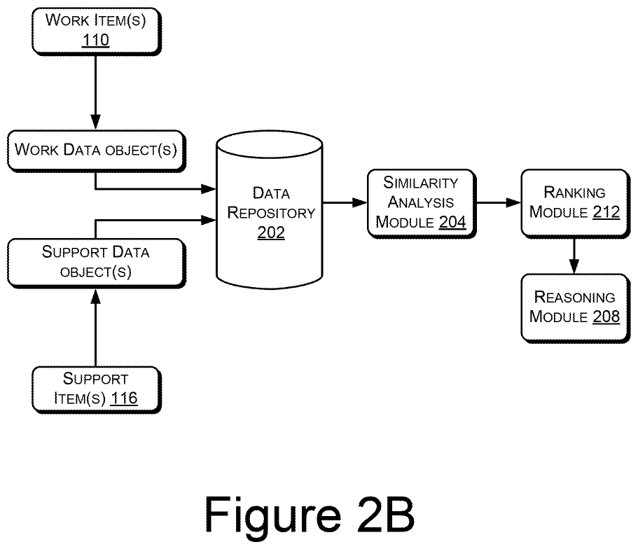

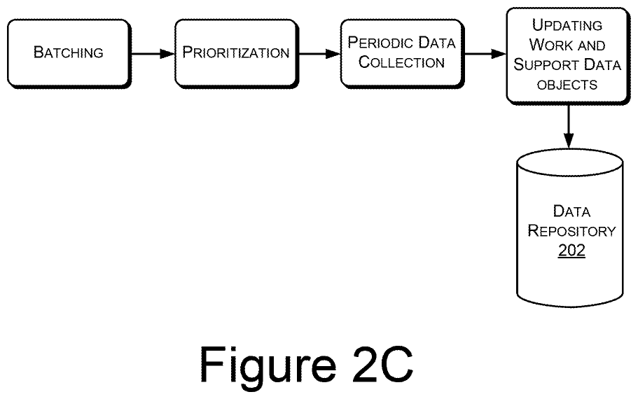

FIG. 2A illustrates a computing environment 200 comprising the system 124, according to one example of the present subject matter. Further, FIG. 2B schematically illustrates communication between different components of the computing environment 200, according to one example of the present subject matter. For the sake of brevity, FIGS. 2A and 2B may be discussed in conjunction with each other.

In one example, the computing environment 200 may be similar to the computing environment 100, as discussed in FIGS. 1A and 1B. In one example, the computing environment 200 may include the system 124 configured to identify linkable items and accordingly link the linkable items. The computing environment 200 may further include, in one example, a data repository 202. In one example, the data repository 202 may be similar to, or a combination of, the data repositories 112, 118, and 112.

In one example, the system 124 may include the data repository 202. In another example, the data repository 202 may be communicably coupled with the system 124 over a communication network, such as the communication network 106 discussed above. As previously discussed, the data repository 202 may store the one or more work items 110. Further, each of the work items 110 may have corresponding work data embeddings, for example, one or more work data objects associated therewith. The work data objects may include information that may describe the corresponding work item. The work data objects may include at least one descriptor variable, as discussed above. In one example, the data repository 202 may store only the work data objects associated with the corresponding work items. The work data objects may be stored as one or more data objects in the data repository 202.

The data repository 202, in one example, may also store the one or more support items 116, as previously discussed. In one example, the one or more support items 116 may be associated with an operational request linked to the one or more service offerings. Each of the support items 116 may have corresponding support data embeddings, for example, one or more support data objects associated therewith. The support data objects may be information that may describe the corresponding support item. The support data objects may include at least one other descriptor variable, as discussed above. The support data objects may be stored as one or more data objects in the data repository 202.

Further, in one example, the one or more work items 110 and the one or more support items 116, and/or data objects associated therewith, may be updated from time to time. For example, the one or more work items 110 and the one or more support items 116 may be modified or deleted by the developer-end entities 108 and the user-end entities 114, respectively. In one example, to modify the work items and the support items, the data embeddings associated therewith, i.e., the work data objects and the support data objects, may be modified. The updated data embeddings may also be referred to as metadata associated with the work and support items. The work and support data objects may accordingly be refreshed and stored in the data repository 202. FIG. 2C schematically illustrates updating the work and support data objects, according to one example implementation of the present subject matter. FIG. 2C may be discussed in conjunction with FIGS. 2A and 2B.

In one example, the data repository 202 may be updated according to a predefined time period to store updated and/or modified work and support items and the work and support data objects. In one example, the updates and modifications may be batched and updated once in a day in the data repository 202. Such update techniques may reduce number of times the data repository 202 is required to be accessed, called, or read and writes operations to be performed. For example, the data repository 202 may be accessed as per the predefined time period, say once in a day, to update the work and support data objects stored therein. In another example, the updates and modifications may be stored in real-time in the data repository 202. In one example, the creation, modification, deletion, and storing of the one or more work and support data objects may be performed and/or managed by the processor 126.

In one example, the processor 126 may perform prioritization of the one or more work and support data objects to be stored in the data repository 202. In one example, the prioritization may be done based on size or length of the at least one descriptor variable and the at least one other descriptor variable associated with the work and support items, respectively. For instance, short textual descriptions may be less prioritized as compared to the textual descriptions that are comparatively elaborate. Such prioritization may help in identification of the at least one descriptor variable and the at least one other descriptor variable, and thereby the work and support data objects, that may have sufficient amount of descriptive information. In another example, the updates and modifications to the work and support data objects may also be prioritized and stored in the data repository 202.

In one example implementation, the processor 126 may access the data repository 202. By accessing the data repository 202, the processor 126 may obtain work data embeddings, such as the one or more work data objects, each linked with a corresponding work item from amongst the plurality of work items 110. Further, by accessing the data repository 202, the processor 126 may also obtain support data embeddings, such as the one or more support data objects, each linked with a corresponding support item from amongst the support items 116.

Further, the processor 126 may analyze the one or more work data objects and the one or more support data objects to identify one or more support items 116 that may possibly be suitable for being linked with the work items 110. In one example, the processor 126 may include a similarity analysis module 204 to identify the one or more support items 116 that may possibly be suitable for being linked with the work items 110. In one example, the similarity analysis module 204 may be configured to determine a contextual similarity between each of the one or more work data objects and each of the one or more support data objects. As discussed above, the contextual similarity may be indicative of, in one example, sematic similarity between the one or more work data objects and the one or more support data objects. The similarity analysis module 204 may determine the semantic similarity using one or more deep learning models and by generating vectors. The one or more deep learning models may be used for encoding the one or more work data objects comprising the descriptor variable (having, for example, textual description) associated with each of the plurality of work items 110 into work vectors. The one or more deep learning models may also be used to encode the one or more support data objects comprising the at least one other descriptor variable (having, for example, textual description) associated with each of the plurality of support items 116 into support vectors. The work and support vectors may be, for example, numerical vectors derived based on the at least one descriptor variable associated with the corresponding work items 110 and the corresponding support items 116. In another example, the similarity analysis module 204 may use specialized Natural Language Processing functions that may encode the descriptor variables embedded in the one or more work data objects and one or more support data objects into a vector form, where similar descriptor variables may have a similar encoding. In one example, the vectors may be stored in a vector database (not shown) communicably coupled with the similarity analysis module 204. The vector database, in one example, may be a part of the data repository 202. In another example, the vector database may be a separate database and may be communicable coupled with at least one of the similarity analysis module 204 and the data repository 202.

The similarity analysis module 204 may perform, for example, a quantitative comparative assessment of the work vectors and the support vectors to estimate a similarity score. The quantitative comparative assessment may be performed to determine similarity between the numerical vectors derived based on the at least one descriptor variable embedded in the one or more work data objects, associated with the corresponding work items 110, and the at least one other descriptor variable embedded in the one or more support data objects, associated with the support items 116. The quantitative comparative assessment may be performed, in one example, by performing a mathematical computation for comparing the work vectors and the support vectors to identify a degree of contextual similarity between the work vectors and the support vectors. Based on the comparison, the similarity analysis module 204 may estimate the similarity score. The similarity score may indicate an extent of contextual similarity between the work vectors and the support vectors. In one example, the similarity score may be indicative of a semantic relationship, or correlation, between each of the one or more work data objects and each of the one or more support data objects. Based on the estimated similarity score, the similarity analysis module 204 may be configured to determine the one or more work data objects and the one or more support data objects that may possibly be contextually, for example semantically, similar to each other.

Based on the similarity score, the similarity analysis module 204 may determine the one or more support items, from amongst the plurality of support items 116, being linkable with the one or more work items, from amongst the plurality of work items 110. For example, if the similarity score is determined to be greater than or equal to a predefined threshold, the work and support data objects may be ascertained to be contextually similar. The similarity analysis module 204 may accordingly link the one or more support items with the one or more work items. However, if the similarity score is determined to be less than the predefined threshold, the work and support data objects may be ascertained to be contextually distinct. In one example, the predefined threshold may be defined by the developer-end entity.

As the one or more work data objects and the one or more support data objects may be associated with the corresponding work item and the corresponding support item, respectively, the similarity analysis module 204 may thus be able to determine the work item and the support item suitable for being linked or associated with each other. Similarly, a plurality of suitable or linkable support items may be identified for one or more work items.

In one example, other techniques to determine contextual similarity may also be used. For example, one or more trained machine learning models may be used to derive the numerical vectors and accordingly determine the similarity score. In another example, one or more language processing modules may be used to analyze the descriptor variables and accordingly derive vectors to determine the similarity score. Based on the determined contextual similarity, the similarity analysis module 204 may be configured to determine the one or more work data objects and the one or more support data objects that may possibly be contextually, say semantically, similar to each other.

Further, in one example, the processor 126 may be configured to generate a recommendation indicating to link each of the one or more support items, from amongst the plurality of support items 116, with the one or more work items, from amongst the plurality of work items 110. In one example, the processor 126 may include a recommendation generator module 206 that may generate the recommendation. The recommendation may indicate, in one example, a correlation between the one or more support items and the one or more work items. In one example, the recommendation generator module 206 may generate the recommendation as a cluster or list (not shown) indicating the one or more support items 116 linked with the one or more work items 110. Therefore, the linkable or suitable support items 116 may automatically be associated or linked with the one or more work items 110, or vice versa. The recommendation generator module 206 may, in one example, render the cluster or the list using the platform or the user interface (not shown). Examples of the platform may include, but are not limited to, one or more webpages, a software application, a graphical user interface (GUI), execution of one or more scripts, one or more Application Programming Interface (API) calls, and the like.

Further, in one example, the processor 126 may render a reasoning indicator to indicate a reason for recommending linking of each of the one or more support items and the one or more work items. In one example, the processor 126 may include a reasoning module 208 configured to determine and render the reasoning indicator. The reasoning indicator may be, in one example, a text-based message indicating a probable reason for generating the recommendation. The reason may be determined by the reasoning module 208 by using different possible techniques. In one example, the reasoning module 208 may use one or more LLM(s). The LLM(s) may have dynamic reasoning capabilities and may determine one or more reasons based on at least the descriptor variables associated with the corresponding work items 110 and the corresponding support items 116. For example, the reasoning module 208 may query the LLM(s) to reason if the one or more support items 116 would possibly fit, or are logically relatable, with the one or more work items 110. In one example, the reasoning module 208 may interact with, or query, the LLM(s) to reason whether the one or more support items 116, each having associated at least one other descriptor variable, fits with the one or more work items 110, each having the at least one descriptor variable associated therewith. In response, the LLM(s) being a generative model, may generate the reason, for example, in form of text. In one example, the reason may be indicative of a basis on which the one or more support items 116 are suitable for being linked with the one or more work items 110. In one example, the LLM(s) may be capable of dynamically generating the reason. For instance, based on the work and support data objects, the LLM(s) may be capable of generating modifying the reason being generated. Thus, for different, or changing, work and support data objects, the LLM(s) may have capability to dynamically generate the reasons. Further, in case the LLM(s) determine that the one or more support items 116 may not be a suitable fit with the one or more work items 110, the LLM(s) may accordingly generate a reason indicating the unsuitability.

Further, in one example, a prompt may also be rendered by the reasoning module 208 to receive an input regarding the reasoning being provided by the reasoning module 208. The input may be provided, for example, by the developer-end entities to indicate the reasoning module 208 whether the provided reasoning is appropriate or any further modifications, to the reasoning, is required or preferred. Based on the input, the reasoning module 208 may tune the reasonings being generated. For example, in case a similar reason, for which an input was received in the past, is determined, the reasoning module 208 may update or modify the reasoning based on the inputs received in past.

In one example, the processor 126 may further render a feedback option to receive at least one of a positive feedback and a negative feedback. The positive feedback may indicate acceptance of the generated recommendation and the negative feedback may indicate rejection of the generated recommendation. In one example, the processor 126 may include a feedback module 210 that may render the feedback option and receive the feedback. In one example, the feedback module 210 may receive the feedback from the developer-end entities. The feedback module 210 may further be configured to tune subsequent linkage recommendations based on the feedbacks received in past, or over a predefined time period. For example, if the generated recommendations receive a negative feedback, the feedback module 210 may ascertain that similar recommendations may not be appropriate. However, if the generated recommendations receive a positive feedback, the feedback module 210 may ascertain that similar recommendations may be appropriate. The feedback module 210 may accordingly communicate with the recommendation generator module 206 to tune subsequent recommendations. In one example, the feedback module 210 may use one or more machine learning (ML) models and may have learning capabilities. Based on the input or feedback received, for example, from the developer-end entities, the feedback module 210 may accordingly communicate with the recommendation generator module 206 to tune subsequent recommendations.

In one example, the feedback module 210 may also communicate with the reasoning module 208 to indicate reception of the positive and negative feedback. The reasoning module 208, based on the feedback, may ascertain whether the generated reasoning is appropriate or any modifications are required. The reasoning module 208 may accordingly ascertain to update the reasonings being generated.

Based on the feedback received, the recommendation generator module 206 may, in one example, link the linkable work items 110 and support items 116, as indicated in the generated recommendation, with each other. Therefore, the linkable support items 116 may be automatically associated with the one or more work items 110 and be rendered, for example, on the user interface or the platform. Further, such an association or linkage between the work and support items may be stored in a data repository, such as the data repository 112 or the data repository 202 that may be accessible to, for example, the developer-end entities.

Further, in one example, the processor 126 may be configured to rank the generated recommendations. The processor 126 may include a ranking module 212 configured to rank the generated recommendations. In one example, the ranking module 212 may arrange the generated recommendations based on the determined similarity score. The generated recommendations may be generated, for example, either in ascending or descending order based on their similarity scores. Therefore, the ranking module 212 may arrange the linkages having high similarity score above the linkages having a comparatively lower similarity score. Therefore, a user, for example the developer-end entities, may be able to identify the linkages that are strongly semantically similar and are highly recommended.

As discussed, the one or more support items 116 and the one or more work items 110 may be linked or associated with each other based on the contextual similarity. For example, the one or more support items 116 (such as tickets) may be related to an issue (say a bug), and there may be a work item 110 (such as an enhancement) that may be related to the bug (say a proposal for fixing the bug). In one example, such relatedness may be determined based on analysis of the descriptor variables associated with each of the support and work items, as discussed. In such cases, the support and work items may be linked based on their contextual similarity, for example, the bug with which they both may be associated. Such relationship may also be leveraged as an additional parameter for ranking results, where the results indicate the linkable support and work items. For example, work and support items, that have such contextual similarity, may be ranked higher as compared to other linkable support and work items. In another example, there can be other parameters also that may be leveraged as additional parameter for ranking the results. For example, based on similarity in name associated with the support items and work items, respectively, ranking of linkable support and work items can be determined. In yet another example, information such as details associated with an owner/creator of the support and work items, respectively, can be further parameters that may be used to optimize ranking the results. For example, a developer-end entity may be an owner/creator of the work item and the user-end entity may be an owner/creator of the support item. Such details may be stored, in one example, in the data repository. The ranking module 212 may determine and utilize a relationship between such details in order to perform ranking. For example, the ranking module 212 may derive a similarity between details of the owners (such as name of the developer-end entity and name of the client-end entity) of the work item and support item. Based on the derived relationship, the ranking module 212 may organize or rank the linkable support and work items in the results. For instance, the support and work items indicating a relationship (such as similarity in details of the owners), such work and support items may be ranked higher.

The ranking may thus be indicative of a degree of contextual similarity between the support and work items on various parameters, some of which have been exemplarily discussed above. However, additional parameters may also be used. Further, ranking may also indicate importance of work and support items. For example, the linkage of support and work items that are ranked higher, may be considered to have more significance or importance as compared to the ones that may have a lower rank. Thus, ranking of the results may indicate an enhanced and more insightful association or linkage between the work and support items and, at the same time, may be more convenient from the point of view of a user (such as the developer-end entities) as the user may be able to easily notice the associations that may be most appropriated.

In one example, entries in the result, i.e., the linkages or associations between the support and work items may also be arranged as per one or more ordering parameters. For example, the ranking module 212 may arrange the linkages either in ascending or descending order based on one or more criteria. In one example, the criteria may be date and/or time of creation/modification/updation of at least one of the support and work items.

Further, in one example, the ranking module 212 may also be configured to filter linkages based on the similarity score. In one example, if the ranking module 212 ascertains that the similarity score for a linkage is below a predefined threshold, the recommended linkage may be removed from the generated recommendation. Therefore, the generated recommendation may only indicate linkages having strong, or at least a minimum required, semantic similarity, thereby providing meaningful and accurate linkages (i.e., results). In one example, the ranking module 212 may also be configured to filter the support items (such as the tickets) which may previously or already be linked to the work items (such as the enhancements). In one example, the ranking module 212 may access the data repository that stores the association or linkage between the work and support items, to determine the support and work items that may have already been linked with each other. The ranking module 212 may accordingly be configured to filter such support items (for example, the tickets) out from the results. The ranking module 212 may thus reduce redundant linkages in results, thereby enhancing quality of the results or linkages being generated.

In another example, the ranking module 212 may be configured to arrange the linkages based on the number of contextually similar support items 116. For example, the work items 110 having more number of contextually similar support items 116 may be ranked above other work items 110 that may have comparatively less number of contextually similar support items 116. Such ranking may, in one example, help the developer-end entities in ascertaining which work items 110 are being highly demanded by the client-end entities. It may thus become possible for the developer-end entities to ascertain the work items, from amongst the plurality of work items 110, on which further actions must be preferably to ensure client satisfaction. Further, as the support items 116 may be indicative of, in some examples, errors, the developer-end entities may be able to ascertain common errors that may have been experienced by most of the client-end entities. The developer-end entities may accordingly be able to prioritize actions required to resolve such error, thereby enhancing efficiency and performance of the product and/or services.

Further, in one example, the ranking and filtering may be implemented by using one or more algorithms and models that may be stacked to implement ranking and filtering. For instance, the processor 126 may be configured to implement the ranking and filtering using different algorithms, ML models, and weights in different models, such as ML or Large Language models (LLMs). As an exemplary workflow, a collection of the one or more work items 110 may be formed by the processor 126. For example, an e5 model may be used for forming the collection of one or more work items 110. The processor 126 may then rank the collected one or more work items 110 using one or more embedding-like models. For example, a cross-encoder model may be used for ranking the collected one or more work items 110. The ranking and filtering by the e5 model and the cross-encoder model may be performed based on different embeddings, i.e., the at least one descriptor variable associated with each of the work items 110. Subsequently, for filtering, the processor 126 may communicate with a LLM like GPT-4 model for filtering the one or more work items 110. For example, using the GPT-4 model, top 5 results, i.e., the top ranked work items 110, may be determined. Using multiple stacked algorithms and models may improve the accuracy of the results and may also feed a smaller set of data to the LLM stage.

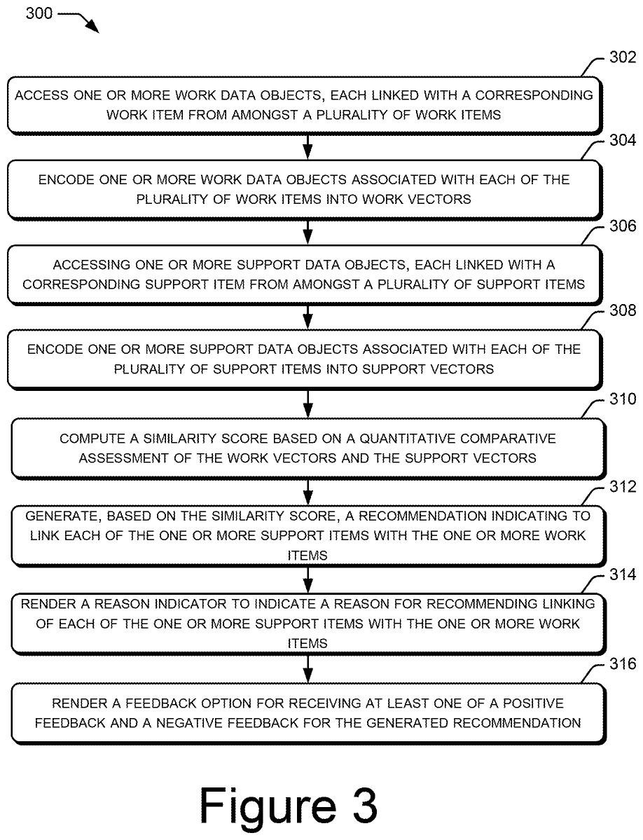

FIG. 3 illustrates a method 300 to generate recommendations by identifying linkable items, according to an example implementation of the present subject matter. The order in which the method is described is not intended to be construed as a limitation, and any number of the described method blocks may be combined in any order to implement the method, or an alternative method. Furthermore, the method 300 may be implemented by processing resource or computing device(s) through any suitable hardware, non-transitory machine-readable instructions, or combination thereof.

It may also be understood that method 300 may be performed by programmed computing devices, such as the system 124 or the processor 126, as depicted in FIGS. 1A-2C. Furthermore, the method 300 may be executed based on instructions stored in a non-transitory computer readable medium, as will be readily understood. The non-transitory computer readable medium may include, for example, digital memories, magnetic storage media, such as one or more magnetic disks and magnetic tapes, hard drives, or optically readable digital data storage media. While the method 300 is described below with reference to the processor 126 and the system 124 as described above; other suitable systems for the execution of these methods may also be utilized. Additionally, implementation of these methods is not limited to such examples.

At block 302, one or more work data objects, each linked with a corresponding work item from amongst a plurality of work items, may be accessed. In one example, each of the one or more work data objects may include at least one descriptor variable associated with the corresponding work item. In one example, the one or more work data objects may be accessed from a data repository, such as the data repository 202.

At block 304, the one or more work data objects associated with each of the plurality of work items may be encoded into work vectors. In one example, the work vectors may be numerical vectors derived based on the at least one descriptor variable associated with the corresponding work item.

At block 306, one or more support data objects, each linked with a corresponding support item from amongst a plurality of support items, may be accessed. In one example, each of the one or more support data objects may include at least one another descriptor variable associated with the corresponding support item. In one example, the one or more support data objects may be accessed from the data repository 202.

At block 308, the at least one other descriptor variable associated with each of the plurality of support items may be encoded into support vectors. In one example, the support vectors may be numerical vectors derived based on the at least one other descriptor variable associated with the corresponding support item.

At block 310, a similarity score may be computed based on a quantitative comparative assessment of the work vectors and the support vectors. In one example, the quantitative comparative assessment may be a mathematician assessment for comparing the work vectors and the support vectors. Based on the comparison, a similarity score may be computed based on a degree of contextual similarity between the work vectors and the support vectors. The similarity score may thus indicate an extent of the contextual similarity between each of the one or more work data objects and each of the one or more support data objects. For instance, the similarity score may be indicative of whether, or to what extent, each of the one or more work data objects and each of the one or more support data objects may semantically be similar.

At block 312, a recommendation indicating to link each of the one or more support items with the one or more work items may be generated based on the similarity score. In one example, if the similarity score, determined for the one or more work data objects and the one or more support data objects, is greater than a predefined threshold, it may be determined that the one or more support items, from amongst the plurality of support items, may possibly be associable with the one or more work items, from amongst the plurality of work items. Accordingly, the recommendation indicating to link each of the one or more support items with the one or more work items may be generated. In one example, the recommendation may be a visual indication for indicating a recommended linking between the one or more support items and the one or more work items. For example, the generated recommendation may be rendered on a user interface. In another example, the recommendation may be a list indicating the one or more support items linked, or associated, with the one or more work items. However, if the similarity score is determined to be less than or equal to a predefined threshold, it may be ascertained that the one or more support items may not be contextually similar, and are thus not linkable with the one or more work items.

At block 314, a reason indicator may be rendered to indicate a reason for recommending linking of each of the one or more support items with the one or more work items. In one example, the reasoning indicator may be a textual indicator including a text-based message indicating a probable reason for recommending association of the one or more support items with the one or more work items. The reason may be determined using different possible techniques. In one example, a large language model (LLM) may be used to determine the at least one reason. The LLM may have dynamic reasoning capabilities and may determine the at least one reason based on the descriptor variables associated with each of the corresponding work items and the corresponding support items. For example, the LLM may be queried to reason whether the one or more support items are actually similar to the one or more work items. In response, the LLM, being a generative model, may generate a response, i.e., the reason. In one example, the reason may be indicative of whether, or to what extent, the one or more support items are suitable for being associated with the one or more work items. In one example, the reason indicator be rendered on the user interface. Rendering of the reason indicator may be prioritized. For instance, the reason indicator may be rendered over all other rendering objects, such as windows, on the user interface.

At block 316, a feedback option for receiving at least one of a positive feedback and a negative feedback for the generated recommendation may be rendered. The positive feedback may indicate acceptance of the recommendation and the negative feedback may indicate rejection of the recommendation. In one example, the feedback option may be rendered on the user interface. Further, the feedback may be used for tuning further or subsequent recommendations. In one example, on receiving the positive feedback for the generated recommendation, the one or more work items and the one or more support items, as indicated in the generated recommendation, may be linked or associated with each other. For instance, on receiving the positive feedback, a relationship may be established or defined between the one or more work items and the one or more support items. The relationship, in one example, may indicate that the one or more work items and the one or more support items are “rationally”, say “semantically”, similar with each other. However, on reception of negative feedback, no relationship or association may be formed the at least one work item and the at least one support item.

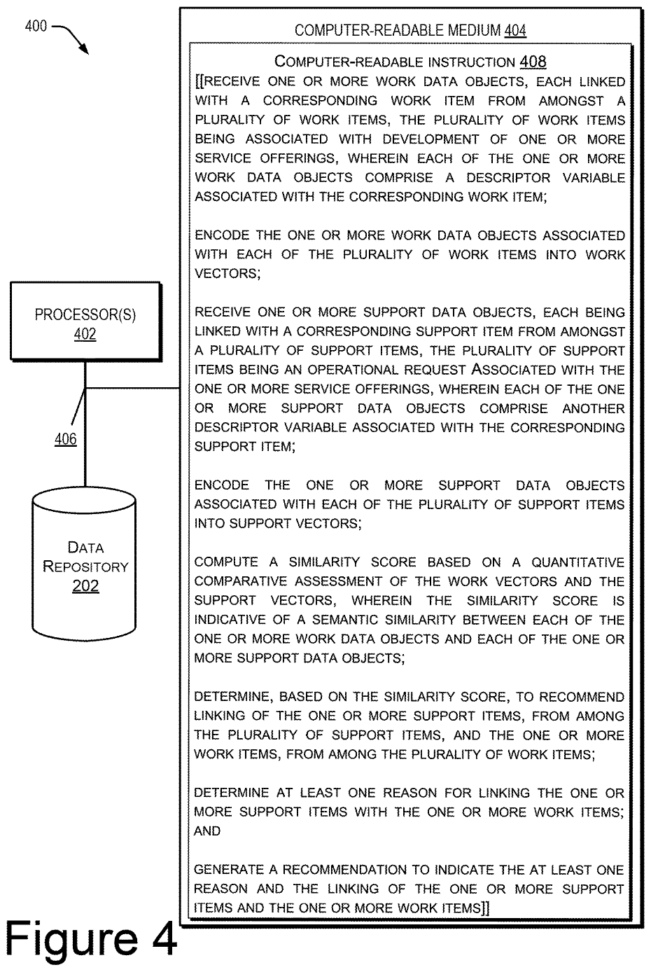

FIG. 4 illustrates a computing environment 400 implementing a non-transitory computer readable medium for generating recommendations by identifying linkable items, according to an example implementation of the present subject matter. In one example, the computing environment 400 includes processor(s) 402 communicatively coupled to a non-transitory computer readable medium 404 through a communication link 406. In an example implementation, the computing environment 400 may be for example, the computing environment 100. In an example, the processor(s) 402 may have one or more processing resources for fetching and executing computer-readable instructions from the non-transitory computer readable medium 404. The processor(s) 402 and the non-transitory computer readable medium 404 may be implemented, for example, in the processor 126 (as has been described in conjunction with the preceding figures).

The non-transitory computer readable medium 404 may be, for example, an internal memory device or an external memory device. In an example implementation, the communication link 406 may be a network communication link. The processor(s) 402 and the non-transitory computer readable medium 404 may also be communicatively coupled to a data repository, such as the data repository 202 over the network communication link 406.

In an example implementation, the non-transitory computer readable medium 404 may include a set of computer readable instructions 408 which may be accessed by the processor(s) 402 through the communication link 406. Referring to FIG. 4, in an example, the non-transitory computer readable medium 404 may include instructions 408 that may cause the processor(s) 402 to receive one or more work data objects, each linked with a corresponding work item from amongst a plurality of work items. The plurality of work items, in one example, may be associated with development of one or more service offerings. Further, in one example, each of the one or more work data objects may include at least one descriptor variable associated with the corresponding work item. Further, the non-transitory computer readable medium 404 may include instructions 408 that may cause the processor(s) 402 to receive one or more support data objects, each linked with a corresponding support item from amongst a plurality of support items. In one example, the plurality of support items may be associated with an operational request for the one or more service offerings. Further, each of the one or more support data objects may include at least one another descriptor variable associated with the corresponding support item. In one example, to receive the one or more work data objects and the one or more support data objects, the non-transitory computer readable medium 404 may include instructions 408 that may cause the processor(s) 402 to access the data repository 202 having the one or more work data objects and the one or more support data objects stored thereon.

Further, the non-transitory computer readable medium 404 may include instructions 408 that may cause the processor(s) 402 to encode the one or more work data objects and the one or more support data objects associated with each of the plurality of work items and each of the plurality of support items into work vectors and support vectors, respectively. In one example, the descriptor variables may be converted into numerical vectors using one or more deep learning models.

The non-transitory computer readable medium 404 may include instructions 408 that may cause the processor(s) 402 to compute a similarity score based on a quantitative comparative assessment of the work vectors and the support vectors. In one example, the similarity score may indicate an extent of contextual similarity between the work vectors and the support vectors, as discussed above. In one example, the similarity score may be indicative of a semantic similarity between each of the one or more work data objects and the one or more support data objects.

Further, the non-transitory computer readable medium 404 may include instructions 408 that may cause the processor(s) 402 to determine, based on the similarity score, to recommend linking of the one or more support items, from among the plurality of support items, and the one or more work items, from among the plurality of work items.

Further, the non-transitory computer readable medium 404 may include instructions 408 that may cause the processor(s) 402 to determine at least one reason for linking the one or more support items with the one or more work items. The reason may be determined, in one example, by querying a large language model (LLM) having reasoning capabilities, as discussed above. In one example, the non-transitory computer readable medium 404 may include instructions 408 that may cause the processor(s) 402 to render a reasoning indicator to indicate the at least one reason. The reasoning indicator may be, for example, a textual indicator indicating a probable reason.

Further, the non-transitory computer readable medium 404 may include instructions 408 that may cause the processor(s) 402 to generate a recommendation to indicate the at least one reason and the linking of the one or more support items and the one or more work items. The recommendation may be rendered, in one example, as a cluster indicating the one or more support items being associated with one or more work items along with the at least one reason for such association. Therefore, the associable or linkable support items may automatically be associated and rendered.

Furthermore, in one example, the non-transitory computer readable medium 404 may include instructions 408 that may cause the processor(s) 402 to render a feedback option for receiving at least one of a positive feedback and a negative feedback, the positive feedback indicating acceptance of the generated recommendation and the negative feedback indicating rejection of the generated recommendation. The feedback may be used for modifying, for example, fine tuning subsequent recommendations based on the positive feedback and the negative feedback received for the generated recommendation. In one example, the one or more work items may be associated with the one or more support items, or vice versa, as indicated in the generated recommendation after receiving the positive feedback for the generated recommendation. Therefore, the associable support items may be automatically associated with the one or more work items, and vice versa.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

What is claimed is:

1. A method using machine learning to improve the performance of a computing system to link data objects, comprising:
identifying a first computing environment comprising a first set of data objects stored in a first data repository;
identifying a second computing environment comprising a second set of data objects stored in a second data repository, wherein the first computing environment is different from the second computing environment and the first computing environment corresponds to developers of a software product or service and the second computing environment corresponds to users of the software product or service;
linking a first data object from the first set of data objects stored in the first data repository to a second data object from the second set of data objects stored in the second data repository, by:
implementing a trained machine learning model to determine one or more similarity scores, wherein the first set of data objects stored in the first data repository are encoded into a first set of vectors and the second set of data objects stored in the second data repository are encoded into a second set of vectors,
estimating a similarity score based on a quantitative comparative assessment of the first set of vectors and the second set of vectors, wherein the similarity score is indicative of a contextual similarity between each of the first set of data objects compared to the second set of data objects, and
linking, based on the similarity score, the first data object from the first set of data objects stored in the first data repository to the second data object from the second set of data objects stored in the second data repository.

2. The method of claim 1, further comprising rendering at least one of (a) a reasoning indicator to indicate at least a reason for linking the first data object with the second data object or (b) a feedback option to receive at least one of a positive feedback or a negative feedback, the positive feedback indicating acceptance of the linking and the negative feedback indicating rejection of the linking.

3. The method of claim 2, wherein tuning is performed of a subsequent linking based on at least one of the positive feedback and the negative feedback.

4. The method of claim 1, wherein the first set of vectors and the second set of vectors are numerical vectors.

5. The method of claim 1, wherein the first and second sets of data objects comprise work items and support items.

6. The method of claim 1, wherein at least one descriptor variable is embedded in a data object, and the at least one descriptor variable corresponds to a textual description or a non-textual description.

7. The method of claim 6, wherein the contextual similarity corresponds to a semantic similarity or relationship of the at least one descriptor variable with another descriptor variable.

8. A system using machine learning to improve the performance of a computing system to link data objects, comprising:
a processor;
a memory for holding programmable code including instructions which, when executed by the system, performs: identifying a first computing environment comprising a first set of data objects stored in a first data repository; identifying a second computing environment comprising a second set of data objects stored in a second data repository, wherein the first computing environment is different from the second computing environment and the first computing environment corresponds to developers of a software product or service and the second computing environment corresponds to users of the software product or service; linking a first data object from the first set of data objects stored in the first data repository to a second data object from the second set of data objects stored in the second data repository, by: implementing a trained machine learning model to determine one or more similarity scores, wherein the first set of data objects stored in the first data repository are encoded into a first set of vectors and the second set of data objects stored in the second data repository are encoded into a second set of vectors, estimating a similarity score based on a quantitative comparative assessment of the first set of vectors and the second set of vectors, wherein the similarity score is indicative of a contextual similarity between each of the first set of data objects compared to the second set of data objects, and linking, based on the similarity score, the first data object from the first set of data objects stored in the first data repository to the second data object from the second set of data objects stored in the second data repository.

9. The system of claim 8, further comprising rendering at least one of (a) a reasoning indicator to indicate at least a reason for linking the first data object with the second data object or (b) a feedback option to receive at least one of a positive feedback or a negative feedback, the positive feedback indicating acceptance of the linking and the negative feedback indicating rejection of the linking.

10. The system of claim 9, wherein tuning is performed of a subsequent linking based on at least one of the positive feedback and the negative feedback.

11. The system of claim 8, wherein the first set of vectors and the second set of vectors are numerical vectors.

12. The system of claim 8, wherein the first and second sets of data objects comprise work items and support items.

13. The system of claim 8, wherein at least one descriptor variable is embedded in a data object, and the at least one descriptor variable corresponds to a textual description or a non-textual description.

14. The system of claim 13, wherein the contextual similarity corresponds to a semantic similarity or relationship of the at least one descriptor variable with another descriptor variable.

15. A computer program product embodied on a computer readable medium, the computer readable medium having stored thereon a sequence of instructions which, when executed by one or more processors, performs:
identifying a first computing environment comprising a first set of data objects stored in a first data repository;
identifying a second computing environment comprising a second set of data objects stored in a second data repository, wherein the first computing environment is different from the second computing environment and the first computing environment corresponds to developers of a software product or service and the second computing environment corresponds to users of the software product or service;
linking a first data object from the first set of data objects stored in the first data repository to a second data object from the second set of data objects stored in the second data repository, by:
implementing a trained machine learning model to determine one or more similarity scores, wherein the first set of data objects stored in the first data repository are encoded into a first set of vectors and the second set of data objects stored in the second data repository are encoded into a second set of vectors,
estimating a similarity score based on a quantitative comparative assessment of the first set of vectors and the second set of vectors, wherein the similarity score is indicative of a contextual similarity between each of the first set of data objects compared to the second set of data objects, and
linking, based on the similarity score, the first data object from the first set of data objects stored in the first data repository to the second data object from the second set of data objects stored in the second data repository.

16. The computer program product of claim 15, further comprising rendering at least one of (a) a reasoning indicator to indicate at least a reason for linking the first data object with the second data object or (b) a feedback option to receive at least one of a positive feedback or a negative feedback, the positive feedback indicating acceptance of the linking and the negative feedback indicating rejection of the linking.

17. The computer program product of claim 16, wherein tuning is performed of a subsequent linking based on at least one of the positive feedback and the negative feedback.

18. The computer program product of claim 15, wherein the first and second sets of data objects comprise work items and support items.

19. The computer program product of claim 15, wherein at least one descriptor variable is embedded in a data object, and the at least one descriptor variable corresponds to a textual description or a non-textual description.

20. The computer program product of claim 19, wherein the contextual similarity corresponds to a semantic similarity or relationship of the at least one descriptor variable with another descriptor variable.
